(19) United States
(12) Patent Application Publication
(10) Pub. No.: US 2016/0211682 A1
(43) Pub. Date: Jul. 21, 2016

(54) Plug-In AC Outlet Electric Device Has Replaceable Rechargeable Battery

(71) Applicant: Tseng-Lu Chien, Walnut, CA (US)

(72) Inventor: Tseng-Lu Chien, Walnut, CA (US)

(21) Appl. No.: 14/979,747

(22) Filed: Dec. 28, 2015

Related U.S. Application Data
(63) Continuation-in-part of application No. 14/829,213, filed on Aug. 18, 2015.
Application No. 14/829,213 is a division of application No. 13/295,562, filed on Nov. 14, 2011.
Application No. 13/295,562 is a continuation-in-part of application No. 12/622,000, filed on Nov. 19, 2009, now Pat. No. 8,434,927.
Application No. 14/829,213 is a continuation-in-part of application No. 14/604,204, filed on Jan. 23, 2015, now Pat. No. 9,196,756.
Application No. 14/604,204 is a continuation of application No. 13/534,281, filed on Jun. 27, 2012, now Pat. No. 8,960,988.
Application No. 13/534,281 is a continuation of application No. 12/710,561, filed on Feb. 23, 2010, now Pat. No. 8,303,158.
Application No. 12/710,561 is a continuation-in-part of application No. 14/739,666, filed on Jun. 15, 2015.
Application No. 14/739,666 is a continuation-in-part of application No. 11/806,285, filed on May 31, 2007.
Application No. 11/806,285 is a continuation-in-part of application No. 14/739,499, filed on Jun. 15, 2015.
Application No. 14/739,499 is a continuation-in-part of application No. 11/806,285, filed on May 31, 2007.
Application No. 11/806,285 is a continuation-in-part of application No. 14/739,397, filed on Jun. 15, 2015.
Application No. 14/739,397 is a continuation-in-part of application No. 11/806,285, filed on May 31, 2007.

(51) Int. Cl. H02J 7/00; F21V 23/06; H02J 7/02; F21S 9/02

(52) U.S. Cl. CPC H02J 7/0027; F21S 9/02; F21V 23/06; H02J 7/0042; H02J 7/02; F21Y 2101/02

(57) ABSTRACT

A plug-into AC outlet electric device has replaceable & rechargeable battery or batteries assembly has AC-to-DC circuit to get DC current to supply or charge DC current to LED or LEDs or rechargeable batteries or device or other product(s). The device or battery-assembly connect with or without the DC current voltage booster circuit or IC which is cost saving feature. While device use less number of battery or battery-assembly, wherein the total batteries-assembly's voltage is less than the LED(s), light source or other functions' trigger or operation voltage, the said battery-assembly or device including at least one of voltage boosting IC or components and related parts and accessories to increase the lower voltage of rechargeable battery or battery-assembly to over or higher than the voltage of device, light source, other electric functions' trigger or operation voltage so can charge or supply power while the device disconnect with AC power source. The said battery-assembly has compartment to install No. 1 to N (Any number) of rechargeable batteries act as power bank to supply power to device, or other electric function or light source while the device is not plug-in the said AC outlet or power fail or people carry or travel or bring the device.

This application is a continuation-in-part of U.S. patent application Ser. No. 14/829,213, filed Aug. 18, 2015, which is a division of U.S. patent application Ser. No. 13/295,562, filed Nov. 14, 2011, which is a continuation-in-part of U.S. patent application Ser. No. 12/622,000, filed Nov. 19, 2009, now U.S. Pat. No. 8,434,927, each of which is incorporated herein by reference.

U.S. patent application Ser. No. 14/829,213, is also a continuation-in-part of U.S. patent application Ser. No. 14/604,204, filed Jan. 30, 2015, now U.S. Pat. No. 9,163,799, which is a continuation of U.S. patent application Ser. No. 13/534,281, filed Jun. 27, 2012, now U.S. Pat. No. 8,960,988, which is a continuation of U.S. patent application Ser. No. 12/710,561, filed Feb. 23, 2010, now U.S. Pat. No. 8,303,158, each of which is incorporated herein by reference.

This application is also a continuation-in-part of U.S. patent application Ser. No. 14/739,666, filed Jun. 15, 2015, Ser. No. 14/739,499, filed Jun. 15, 2015, and Ser. No. 14/739,397, filed Jun. 15, 2015, each of which is a continuation-in-part of U.S. patent application Ser. No. 11/806,285, filed May 31, 2007.

### BACKGROUND OF THE INVENTION

This application has subject matter in common with U.S. patent application Ser. Nos. 12/624,621, 12/622,100, 12/318,471, 12/318,470, 12/318,473, 12/292,153, 12/232,505, 12/232,035, 12/149,963, 12/149,964, 12/073,095, 12/073,889, 12/007,076, 12/003,691, 12/003,809, 11/806,711, 11/806,285, 11/806,284, 11/566,322, 11/527,628, 11,527,629, 11/498,874, 12/545,992, 12/806,711, 12/806,285, 12/806,284, 12/566,322, 12/527,628, 12/527,629, 12/527,631, 12/502,661, 11/498,881, 11/255,981, 11/184,771, 11/152,063, 11/094,215, 11/092,742, 11/092,741, 11/094,156, 11/094,155, 10/954,189, 10/902,123, 10/883,719, 10/883,747, 10/341,519, 12/545,992, and 12/292,580. The above-listed applications include disclosures related to light devices such as night lights powered by an AC outlet, battery, solar cell, or other power source, the light devices using optics theory to create a plurality of LED light images on a surface and which may contain more than one light source, function, or optics means.

The current invention applies the persistence of vision effect to a desktop or outlet plug-in LED light device to cause LED array light effects to be seen by viewers as light patterns such as a message display, time display, color changing display, word display, logo display, or advertisement display. It also provides a sealed-unit with self-test certification issued by laboratories for add-on shades to provide a more exciting and eye-catching LED device. Each light device has a desired power source, circuitry, switch, sensor, timer and/or other related parts and accessories to cause the light to have a long life and be convenient to people to use.

The light device with special effects of the current invention may include one or more of the following 14 features:

1. The LED light device with special effects may include a special effects mechanism made up of at least one LED array arranged on a substrate, and at least one spin means for rotating the substrate means at a predetermined speed (RPM) about an axis extending from the spin means. The predetermined speed is preferably sufficient to provide a persistence of vision effect as described below. The LED or LEDs of the light device will turn on and off according to a predetermined pattern, timing, color, function, and/or effects and controlled by an appropriate circuit, switch, sensor, timer, auto turn on and turn off, power source (DC, AC, or interchangeable power source), gear sets, motor, integrated circuit (IC), and/or conductive means to cause the light device to exhibit desired light patterns such as a message display, time display, color changing display, word display, logo display, and advertisement display. The LED light device having persistence of vision properties includes a desktop or outlet plug-in type housing for any substrate, spin means, LED(s) or LED arrays, motor, switch, sensor, circuit, IC, and power source means provided in the light device. The LED light device may further incorporate a vibration absorbing means to absorb all vibrations of the motor or spin means vibration when people put the device on a desk top or plug-in outlet.

2. The LED light device with special effects may include a sealed unit for at least one LED, the sealed unit having its own safety certification issued by a laboratory to meet the applicable safety standard and a receiving means to allow different shades to be added onto the sealed unit to obtain a final LED light device with special effects provided by the shades. The added on shades may be made of plastic, paper, wood, a laser piece, a hologram piece, an air-bag, a balloon, assembly pieces, a light block out means, or a grill to cause the final LED light device with special light effects to have an eye-catching appearance. Because all electrical parts are in the already-certified sealed unit, the final LED light device does not need to pass any other laboratory's further tests. As a result, the shade can be made of any kind of material. The final LED light device may use any power source, such as a battery, outlet, or power source that is interchangeable between DC and AC power sources for desk top or plug-in application.

3. The light device with special effects may be arranged to meet the requirements of persistence of vision theory to create an illusion based on the inertia of a human eye, which takes 1/16 to 1/24 second to respond to an image. When the LED or LEDs are turned off for periods of less than 1/16 to 1/24 second, the off time will not be noticed by a viewer and the image will appear to be steady.

4. The LED light device with special effects may be a tap light that is activated when a top cover is touched.

5. The LED light device with special effects may have a ball shape housing, and rotating means inside the ball to show the special effects, and spin means under the ball to provide a better appearance.

6. The spin means of the LED light device with special effects may be a motor with fan blades having a substrate to install the LED(s) or LED array within the said fan blade.

7. The spin means of the LED light device with special effects may be a motor with bars that include a substrate to install the LED(s) or LED array within the bars.

8. The spin means of the LED light device with special effects may be a motor with frame substrate to install the LED(s) or LED array within the frame.

9. The spin means of the LED light device with special effects may be a motor with a round disc substrate to install the LED(s) or LED array within the disc.

10. The spin means of the LED light device with special effects may be a motor with a geometric shape substrate to install the LED(s) or LED array with the geometric shape substrate.

11. The LED light device WITH special effects may include a switch, sensor, and/or timer means to control the circuit to provide predetermined functions.

12. The power source of the LED light device with special effects may come from a battery, USB outlet, generator, chemical power source, green power source, wind power source, outlet, extension cord, power strips or other power generator device(s).

13. The LED light device may be an LED light device with power saving features, including: at least one LED for a light source, and at least one housing having space to install circuit means, conductive means, electric components parts and accessories, switch means, sensor means, an integrated circuit (IC), and/or micro controller to connect with a conventional market-available power source to cause the said LED or LEDs to turn on and off according to a predetermined function, effects, duty cycle, color, and brightness, the LED or LEDs turning off for a certain percentage of each cycle that is shorter than the time required to meet the persistence of vision of human eye, i.e., more quickly than the human eye's response time of 1/24 to 1/16 second as noted above, so that the blinking LED or LEDs will appear to be continuously on.

14. The LED light device with special effects may have the additional cost saving feature, in case the power source is batteries, wherein the total batteries' voltage is less than the LED trigger voltage, the light device including voltage boosting components and related parts and accessories to increase the lower voltage to over the LED or trigger voltage.

1. An plug-into AC outlet LED Night light has replaceable & rechargeable battery or batteries assembly

At least one of the said Plug-In AC outlet LED night light has AC-to-DC circuit to get DC current to supply DC current to LED or LEDs or replaceable rechargeable battery-assembly or-and other functions.

2. An plug-into AC outlet LED Night light has replaceable & rechargeable battery or batteries assembly as claim 1,

The said light device or battery-assembly connect with or without the DC current voltage booster circuit which is additional cost saving feature, in case the battery or battery-assembly, wherein the total batteries-asse

3. An plug-into AC outlet LED Night light has replaceable & rechargeable battery or batteries assembly as claim 1,

The said total voltage of replaceable rechargeable battery-assembly is less than the LED(s), light source or other functions' trigger or operation voltage,

4. An plug-into AC outlet LED Night light has replaceable & rechargeable battery or batteries assembly as claim 1,

The said battery-assembly or light device including at least one of voltage boosting IC or components and related parts and accessories to increase the lower battery-assembly's voltage to over or higher than the LED or other electric functions or trigger or operation voltage.

5. An plug-into AC outlet LED Night light has replaceable & rechargeable battery or batteries assembly as claim 1,

The said battery-assembly has compartment to install No. 1 to N (Any number) of rechargeable batteries act as power bank to supply power to other electric device or light source while the LED light is not plug-in the said AC outlet

6. A replaceable rechargeable battery assembly to supply DC power to the other electric device consist;

The said replaceable rechargeable battery assembly has its compartment and can easily install, replace, assembly, dis-assembly the battery and has easily open, close of the battery cover, hinge, door.

The said compartment is part of the main electric device.

At least one replaceable rechargeable battery fit into compartment space with booster circuit, IC, related electric parts & accessories to raise the less battery-assembly DC voltage to higher DC voltage to has enough higher DC voltage to charge or supply the DC power to the other electric device(s) or products has built-in the said battery-assembly.

7. A replaceable rechargeable battery assembly to supply DC power to the other electric device consist as claim 6,

The said main electric device (s) has at least one of charging circuit(s) to charge the said replaceable rechargeable batteries.

8. A replaceable rechargeable battery assembly to supply DC power to the other electric device consist as claim 6,

The said main electric products including but not limited of
(AA) AC plug-in outlet multiple functions LED night light,
(BB)Power fail night light,
(CC)LED light, flashlight,
(DD)AC outlet Plug-in USB Charger products, or
(EE)Portable DC Power bank has USB wires has 2 USB-plug for electric delivery.
(FF)AC outlet plug-in electric device has at least one add functions but not limit any combination from
(a) motion sensor,
(b) remote controller,
(c) blue-tooth connection,
(d) wireless controller,
(m) wireless communication,
(n)camera,
(o) recording,
(p) microphone,

### BRIEF DESCRIPTION OF THE DRAWINGS

FIGS. 1 to 4 show a first preferred embodiment of the current invention, including a sealed-unit with its own laboratory test certification incorporated with add-on different shades made bags that can be filled up with air, liquid, miniature items, laser film, hologram film or other material piece(s).

FIGS. 5-1 to 5-5 show a preferred construction for the sealed unit of FIGS. 1-4, with different functions, features and an interchangeable power source

FIGS. 5, 5-6, and 5-7 show details of how to assemble the add-on shade to the sealed-unit of the preferred embodiment.

FIGS. 6 and 7 show a second preferred embodiment having a sealed unit with a grill or light block-out shade to cause the LED light beams to spread out to surrounding areas and provide electric wallpaper light effects.

FIGS. 8, 9, 10, and 11 show a preferred embodiment having rotating means and spin means with a preferred geometric shape substrate are installed the LED(s) or LED array to form a message, light pattern, color changing pattern, and/or time display.

FIGS. 12 and 13 illustrate one of the splendid light image effects created by the current invention an LED(s) or LED arrays that change faster than the slow human eye reaction time.

FIG. 14, FIG. 14A, FIG. 14B, FIG. 14C, FIG. 15, FIG. 15A, FIG. 15B, FIG. 15C and FIG. 15D show the 3^{rd} and 4^{th} preferred embodiment having main electric products is Plug-in AC outlet travel USB charger and Plug-in AC outlets Multiple functions LED light or other Plug-in AC outlet electric device, all these products has compartment to easily install, assembly, replace, dis-assembly replaceable rechargeable batteries or battery-assembly (N piece battery holder in one unit) with or without the voltage booster circuit, IC, related electric parts & accessories so can charge or supply DC power to other DC powered electric device.

FIG. 16 is a flow chart illustrating power distribution functions of a preferred plug-in AC outlet LED night light with USB charger and battery charger functions.

### DETAILED DESCRIPTION OF THE PREFERRED EMBODIMENTS

As explained above, the current invention may apply the persistence of vision effect to enable the LED(s) or LED array to form light patterns such as color changing patterns, or a time display. The effect is based on the inertia of the human eye which has a response time of around 1/24 to 1/16 second. Hence, the LED(s) or LED array light can be controlled to change faster than the 1/24 (41.67 msec) to 1/16 (0.0625 sec) second response time so that even though an object moves faster than the human eye response time, the last image stays in the human eye and brain for a period of time. This effect is possible because the LED response time is very short, around 10 msec or less. Hence, if an object appears in front of the human eye for more than 16-24 pictures in a second, people will think all pictures are continuous. Hence, the current invention uses appropriate circuits, control means, an IC, and/or a micro controller to cause the LED or LEDs to blink much faster than 16-24 times (cycles) per second, with each cycle having a 10% turn-on duration and 90% turn-off duration to save up to 90% of the power consumption or increase battery life up to nine times more than would be the case with a full steady-on condition. This is a significant power saving for all battery power source applications. It will further be appreciated that new LED technology may be coming soon which will make the LED have an even quicker response time of less than 10 msec, perhaps 5 msec time or 2 msec to provide even more power saving. To thus adjust the turn-on and turn-off duration time for each cycle will enable more power saving devices to meet the green world concept.

To provide further cost saving in the case of a battery-powered unit, the preferred light device can use cheap batteries with a voltage lower than the LED trigger voltage and voltage boosting electric components, parts and accessories to raise the battery's lower voltage to trigger the LED or LEDs. This can reduce the quantity of batteries required and save substantial cost.

The cost saving to use less rechargeable batteries which inside the main electric product's compartment can has(1) the cost saving by booster circuit can buy market easily can get rechargeable battery or batteries not buy the expensive batteries or even need change a whole electric device like iphone battery can not replaceable. (2) The cost saving by booster circuit can use even 1pc market anywhere can buy rechargeable battery so the weight will be very light compare with market available all kind of power bank which from 1,000 ma to 10,000 ma or more higher ma but the weight is N times heavy than the 1 pcs of rechargeable battery of current invention. So the current invention for cost saving circuit for main electric products is big features and also had detail more features as below listed 1 to 9 points.

1. An plug-into AC outlet LED Night light has replaceable & rechargeable battery or batteries assembly

At least one of the said Plug-In AC outlet LED night light has AC-to-DC circuit to get DC current to supply DC current to LED or LEDs or replaceable rechargeable battery-assembly or-and other functions.

2. An plug-into AC outlet LED Night light has replaceable & rechargeable battery or batteries assembly as claim 1,

The said light device or battery-assembly connect with or without the DC current voltage booster circuit which is additional cost saving feature, in case the battery or battery-assembly, wherein the total batteries-asse

3. An plug-into AC outlet LED Night light has replaceable & rechargeable battery or batteries assembly as claim 1,

The said total voltage of replaceable rechargeable battery-assembly is less than the LED(s), light source or other functions' trigger or operation voltage,

4. An plug-into AC outlet LED Night light has replaceable & rechargeable battery or batteries assembly as claim 1,

The said battery-assembly or light device including at least one of voltage boosting IC or components and related parts and accessories to increase the lower battery-assembly's voltage to over or higher than the LED or other electric functions or trigger or operation voltage.

5. An plug-into AC outlet LED Night light has replaceable & rechargeable battery or batteries assembly as claim 1,

The said battery-assembly has compartment to install No. 1 to N (Any number) of rechargeable batteries act as power bank to supply power to other electric device or light source while the LED light is not plug-in the said AC outlet

6. A replaceable rechargeable battery assembly to supply DC power to the other electric device consist;

The said replaceable rechargeable battery assembly has its compartment and can easily install, replace, assembly, dis-assembly the battery and has easily open, close of the battery cover, hinge, door.

The said compartment is part of the main electric device.

At least one replaceable rechargeable battery fit into compartment space with booster circuit, IC, related electric parts & accessories to raise the less battery-assembly DC voltage to higher DC voltage to has enough higher DC voltage to charge or supply the DC power to the other electric device(s) or products has built-in the said battery-assembly.

7. A replaceable rechargeable battery assembly to supply DC power to the other electric device consist as claim 6,

The said main electric device (s) has at least one of charging circuit(s) to charge the said replaceable rechargeable batteries.

8. A replaceable rechargeable battery assembly to supply DC power to the other electric device consist as claim 6,

The said main electric products including but not limited of

(1) AC plug-in outlet multiple functions LED night light,

(2) power fail night light,

(3) LED light,

(4) flashlight,

(5) AC outlet Plug-in USB Charger products, or

(6) Portable DC Power bank has USB wires has 2 USB-plug for electric delivery.

(7) AC outlet plug-in electric device has at least one add functions but not limit any combination from

(a) motion sensor,

(b) remote controller,

(c) bluetooth connection,

(d) wireless controller,

(e) wireless communication,

(f) camera,

(g) recording,

(h) microphone,

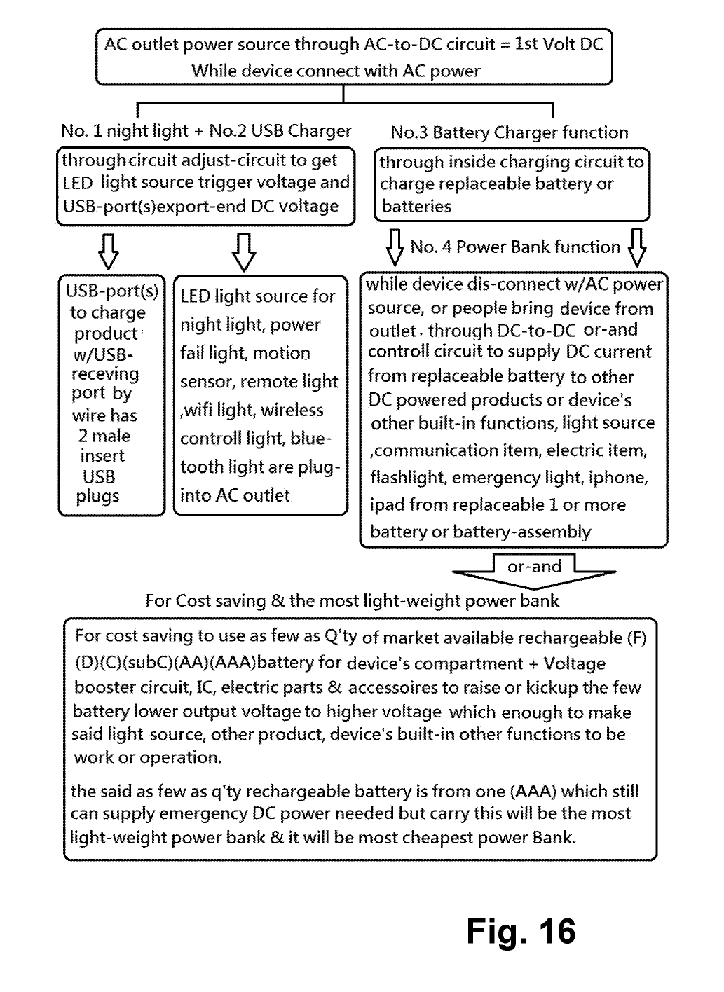

For more simple understand the current invention for multiple function for Plug-in AC outlet LED device please refer to FIG. 16.

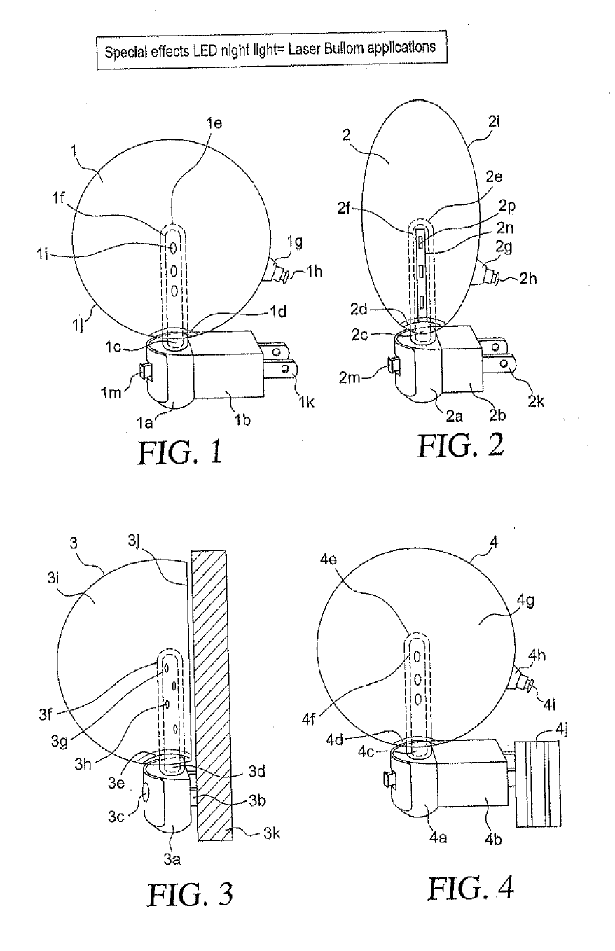

The current invention can include any of the 14+ 12 features described above, as described below in connection with FIGS. 1-13:

As shown in FIGS. 1 to 4, the first preferred embodiment of the current invention includes a sealed-unit with its own laboratory test certification and a plurality of different add-on shades made by bags which can be filled up with, air, liquid, miniature decorative objects, laser film, hologram film or material piece(s) other than the afore-mentioned decorative objects, laser film, or hologram film. The sealed unit (1a)(2a)(3a)(4a) of each of FIGS. 1-4 includes housings having a same front housing part and different rear parts (1b)(2b)(3b)(4b) which have different lengths from the wall to the sealed-unit to accommodate the top balloon shades (1) (2) (3)(4). Each balloon shade has a center channel (1e) (2e)(3f)(4e) into which tubular extensions (1f)(2f)(3g) (4f) of the sealed unit are easily inserted before the balloon is filled up with air, liquid, and/or miniature decorative objects. After the air, liquid, and/or miniature decorative objects are filled into the balloon, the channels will become narrow and tightly hold the tube parts so that they are very difficult to move away. The LED or LEDs inside the tube parts may have a variety of arrangements such as the ones disclosed in the above-cited applications of the inventor. The tube can also be filled up with reflective material, air bubbles, LEDs, glitter, and air to provide the whole shade with a desired light performance.

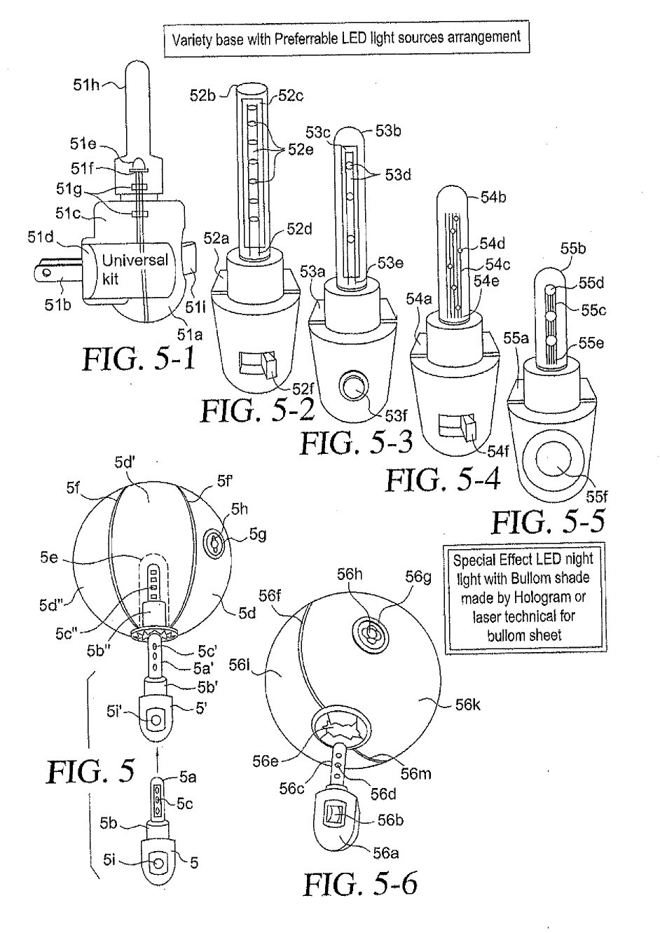

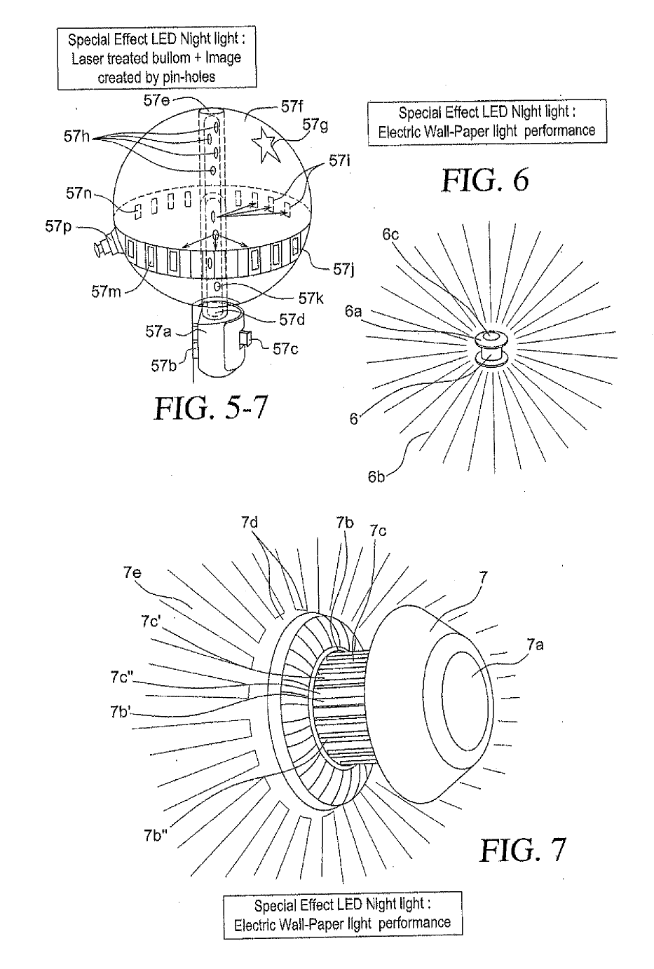

FIGS. 5-1 to 5-5 show light devices having sealed units and a variety of different functions. FIG. 5-1 shows a sealed unit in the form of an interchangeable power source (51d) including one LED (51e) on a base of tube part (51h), the sealed unit including a manual switch (51i). FIG. 5-2 shows a light device with tube part (52b), and a sealed unit having a manual switch (52f) and LEDs (52e) installed on an elongate printed circuit board (52c). The light device of FIG. 5-3 has a tube part (53b), auto sensor switch (53f), and LEDs (53d) installed on PCB (53c). The light device of FIG. 5-4 has a manual switch (54f) on the sealed unit and a tube part (54b) having a plurality of LEDs that face in different directions and are connected to conductive wires to provide multi-directional LED illumination. The light device of FIG. 5-5 has motion sensor switch (55f) on the sealed unit and a tube part (55B) having a plurality of LEDs installed on flexible electric wire cable.

The present invention may use the more than one optics means arrangements described in the inventor's U.S. patent application Ser. No. 11/806,284, which teaches outer optic means surrounding a tubular optics means containing LEDs.

FIGS. 5, 5-6, and 5-7 illustrate the use of laser or hologram film or pieces to form a balloon or assembly that can be added on the tube parts to provide a special effects LED light device.

FIGS. 6 and 7 show arrangements similar those of copending U.S. patent application Ser. No. 12/622,000 filed on Nov. 24, 2009 and directed to an “Interchangeable Universal Kits for all LED Lights.”

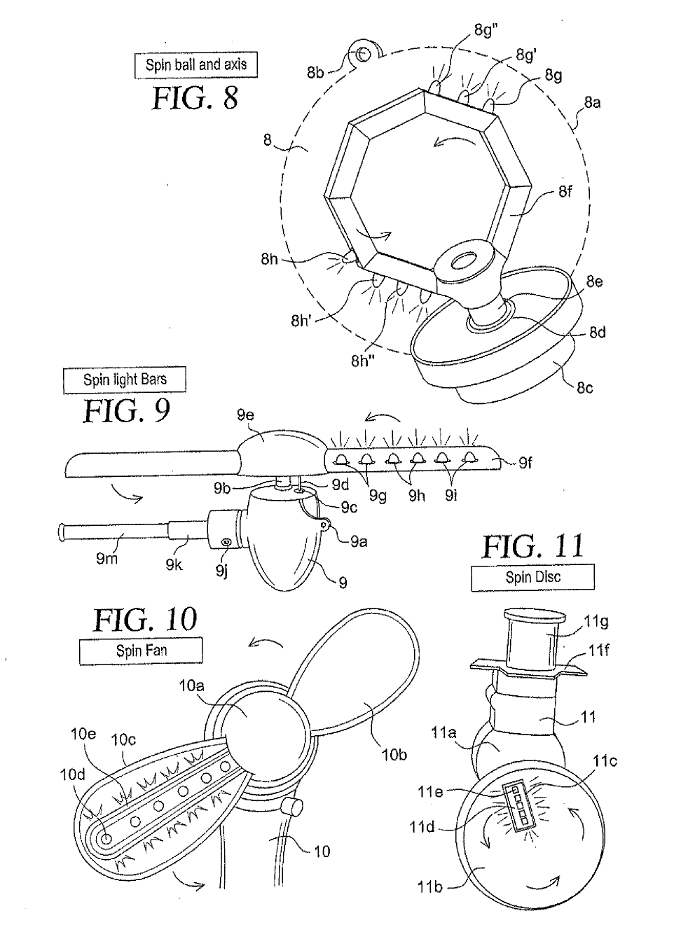

FIG. 8 shows LEDs (8g) (8g′) (8g″) and LEDs (8h) (8h′) (8h″) installed on a substrate (80 assembled with spin means (not shown) inside a base housing (8c). The substrate is sealed within a transparent ball shaped housing (8a) to allow people to see the LEDs' light performance for desk top or outlet plug-in applications. The base (not shown) of the light device may be arranged to absorb vibrations when the light device is put on a desktop or plugged-into an outlet.

FIG. 9 shows a light device with a soft material substrate (9f) in a bar shaped design with a dome center area to deliver electricity by conductive means (9d) and a conductive axis (9b) of a spin means. The dome center area enables assembly of the bars with respect to the spin mean axis to cause the two bars to rotate when the switch (9j), sensor, or control means is activated. The plurality of LEDs (9g) (9h) (9i) can be any number to form a message display having a desired color, brightness, time, message, and words for presentation to a viewer. The LED or LEDs connect with a circuit board or micro controller for time display (such as PIC 16F84) having an integrated circuit (IC) that can display the time, message, or words according to conventional market available skill. The spin means (not shown) can be a motor and is sealed within a motor housing (9) with fastening means assembled with all related parts and accessories e for desktop or plug-in application to make the final LED device.

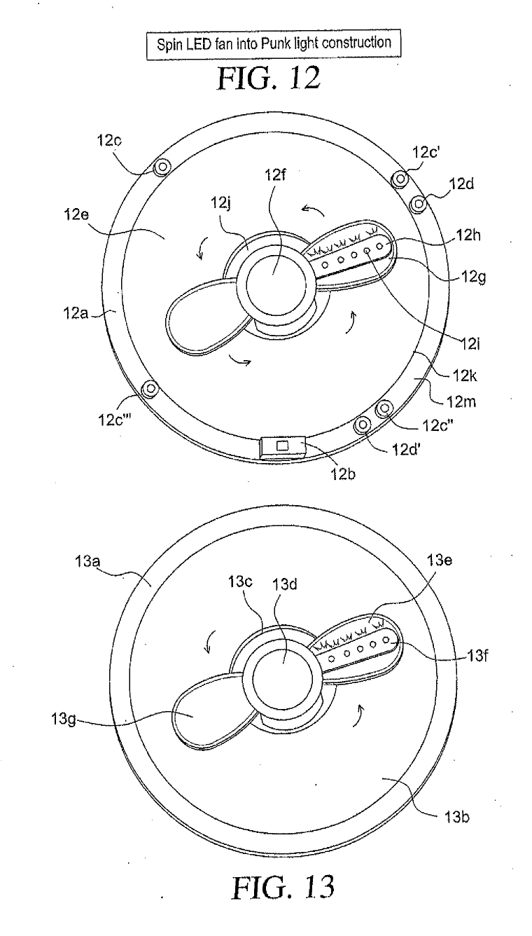

The light device of FIGS. 10 and 11 is similar to that of FIG. 9 and has the same LED or LEDs (10d) (11e) on a fan-blade (10c) or round disc (11c) arranged to rotate about the axis of a spin means to create a desired light performance. These light devices can be combined with a preferred housing to become a final LED light device as shown in FIGS. 12 and 13.

FIGS. 12 and 13 show how to arrange the preferred embodiments of FIGS. 7, 8, 9, and 10 into a housing to become a final LED device with special effects. The device may have any of a switch, sensor, timer, control means, circuit, micro controller, IC, conductive means, motor means and power source to enable it to have a special LED light performance.

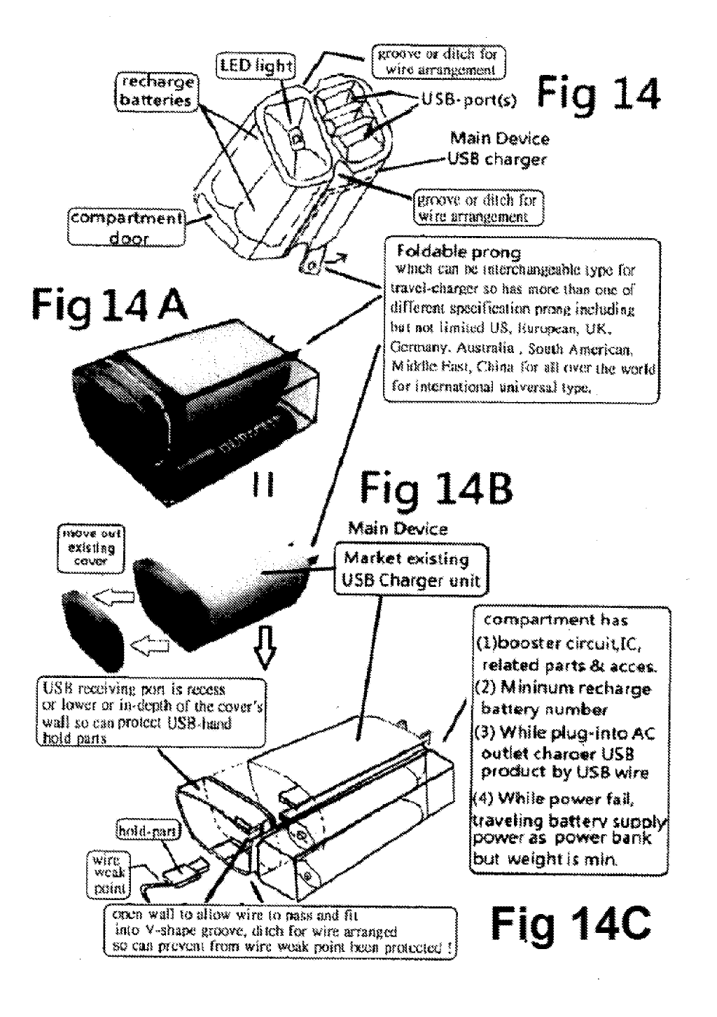

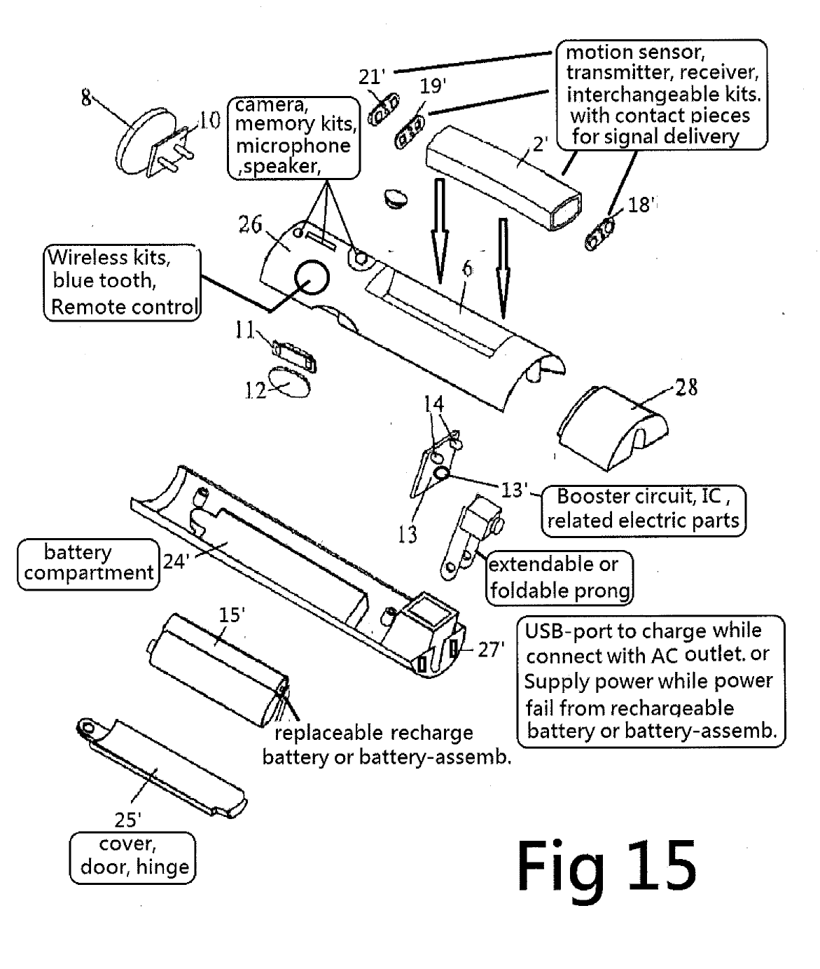

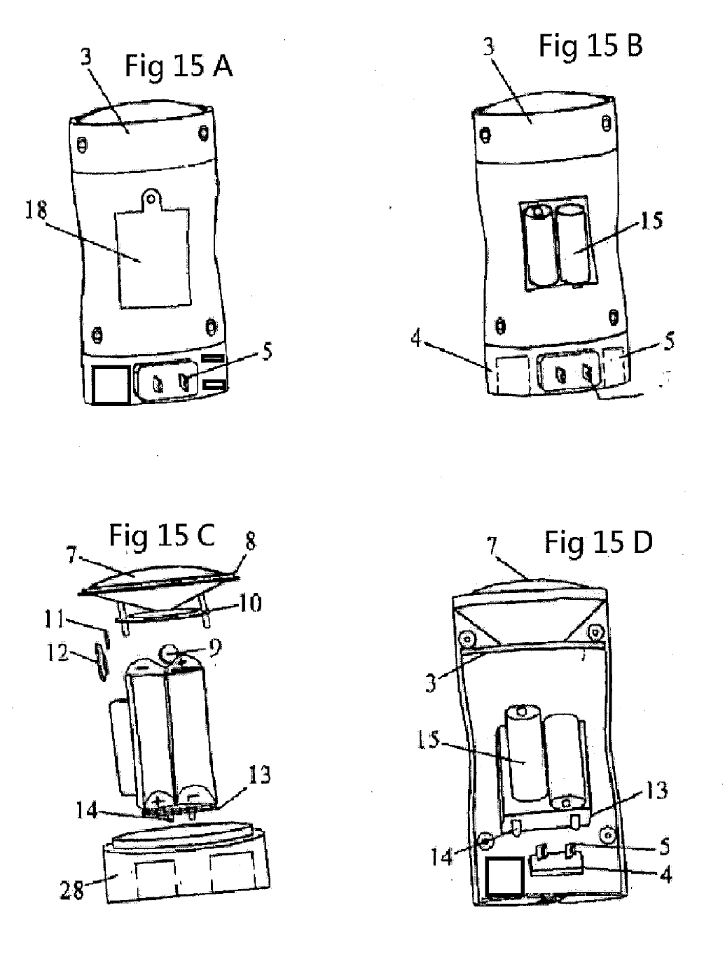

From FIG. 14 and FIG. 14A, FIG. 14B, FIG. 14C and FIG. 15, FIG. 15A, FIG. 15B, FIG. 15C show the 3^{rd} and 4^{th} preferred embodiment having main electric products is Plug-in AC outlet travel USB charger and Plug-in AC outlets Multiple functions LED light or other Plug-in AC outlet electric device, all these products has compartment to easily install, assembly, replace, dis-assembly replaceable rechargeable batteries or battery-assembly (N piece battery holder in one unit) with or without the voltage booster circuit, IC, related electric parts & accessories so can charge or supply DC power to other DC powered electric device.

From FIG. 14 show a new molded USB Charger which is directly plug-into AC outlet to get the AC power source and through the inner AC-to-DC circuit and battery charging circuit so at least 2 functions including;

(1) Charge the other USB-port(s) electric device while the built-in AC-to-DC circuit change the AC current to 5.0 Volt DC current through at least one of the USB-ports for DC current.

(2) Through the USB Charger's built-in battery charging circuit including AC-to-DC or-and DC-to-DC circuit or-and other control circuit to safe charge the said USB-Charger's compartment inside replaceable rechargeable battery or battery-assembly. While the said USB-Charger is disconnect with AC power source from outlet, the inside control circuit will allow the USB-port(s) to export the battery or battery-assembly's DC current to other electric device to trigger or operate the other products or USB-Charger's added function(s).

For Cost saving and light-weight consideration, The current invention preferred to use the market available all kind of rechargeable battery such as (AAA) or (AA) or (Sub-C) or (C) or (D) or (F) batteries which can easily get from all Chain stores and not use the expensive special non-replaceable batteries which use for iphone, ipad so people can get the reasonable and cheap and everywhere rechargeable batteries to save cost than throw away non-replaceable battery communication device or consumer electric device or computer device.

For Light weight consideration, the current invention preferred to use the any where easily pruchasement (AAA) (AA) (SubC) (C) (D) (F) or other size rechargeable battery and only use at least one which has only 1.2 V incorporate with voltage booster circuit, IC, related parts & accessories to kickup or raise from 1.2V or 2.4V or 3.6 Volt to higher voltage to meet the trigger or operation or working voltage for light source, device, functions required. The current invention to use the most less number of replaceable & rechargeable battery or batteries assembly so can work as market available all kind of POWER BANK to people to operate the power out device at any time. The current invention also consider people to carry the market available power back which is too Big and too heavy and only 1 functions just for supply DC power, so add the less number of replaceable & recharge battery or batteries-assembly so can have same function as all market power bank but the current invention offer (1) Not only supply DC current like power bank but less battery with booster circuit is the lighted weight But Also (2) The current invention the lightest weight power back is built-in with the main products including the USB-Charger or LED night light or LED multiple functions light or LED power fail light or motion sensor LED light those all are plug-into the AC outlet device.

From FIG. 14 also disclosure the foldable prong can interchange to all kind of the different prongs for different country as market available type to insert the other country plug-unit overlay and insert the existing prong so can meet the each country safety standard for the prong specification. The said current invention all prong is 2 prong-pins without the ground-pin. It is appreciated the current invention the all 2 prong-pins unit can also use the 3 prongs which including the ground-pin.

From FIG. 14, FIG. 14 A, FIG. 14B, FIG. 14C and FIG. 15A, FIG. 15B, FIG. 15C, FIG. 15D all embodiment can charge be charged products inner energy storage unit including rechargeable battery or be power the other functions by supply DC to the other function's circuit. The power output end from the said main products or LED light or Multiple function LED light or electric device can export Direct current from USB export port(s) or special design export-port which is not limited for the current invention which depend on market requirement.

While the main product has USB-Charger which has function: while plug-into the AC outlet, It will be charge the other USB device or products from the USB-ports to charge the USB related other products including ipad, iphone, communication device, computer device, consumer electric device. However, while the main product is USB Charger disconnect with AC outlet power source or while people bring the travel USB Charger with foldable prongs, the main product USB charger will instantly to change the power source from the AC-outlet to the compartment's inside replaceable rechargeable batteries so can the me USB-ports to become the POWER BANK to give DC current to other be charged or be powered's power source which is not like AC Outlet power source which is unlimited whenever the main product plug-into AC outlet. The replaceable recharge battery or battery-assembly is offer limited power for emergency use only for short time to continue to use electric device and get the limited power from the cost saving and super light-weight and super compact size POWER BANK of the current invention. Further more, the current invention's main product's compartment also can load the non-rechargeable batteries that can buy everywhere to put into through the same DC voltage booster circuit still can offer the emergency time needed limited power so this is the other features for current invention for the cheapest, lightest weight, most compact, most convenient, get everywhere Rechargeable or non-rechargeable battery for main products compartment use, so the current invention is very unique and compare with market all super big size, super heavy, need to connect with other transformer circuit to charge, never can replace inside batteries, risk for fire for big current storage to cause damage.

The current invention while main product is a USB Charger or Travel USB Charger can offer the super quickly charger up to 2.4 A, 4.8 A, 7.2 A or other output while had the AC outlet near by. While lack of the AC outlet nearby can use the super light weight, super cheap, super compact size, no risk for its limited 1, 2, 4, 6, 8 number replaceable rechargeable batteries or non-replaceable battery can get everywhere with few watt so even exposure it is no harm to people than the market other big/heavy/super expensive/never replaceable power bank without the select or preferred more function up to 12 functions build-in for the main products. These all are current invention so this is Big Improvement not only these more than one function for all electric products but also had recess USB-port has surround walls to protect the USB-wire's head or bend-wires been damage so consumer need buy the wires with 2 plugs very often . . . . The current invention also teach the V-groove, ditch or hooks, bar, holder, catcher, retractable hook, bars to make the USB-wire for nice and net wire arrangement and also prevent damage the thin and few conductive wires inside wire skin been break so can save consumer money again. All these are the current invention features, big improvement. Any similar concept, equal function, replaceable skill, alternative arrangement should be still fall within the current invention's claim scope.

FIG. 14 show the 3^{rd} preferred embodiment is new design unit which has Plug-Into AC outlet USB Charger has built-in replaceable rechargeable batteries also has the special design for recess USB receiving-ports which lower than the surrounding walls around 15 mm to 25 mm so can protect the insert-into male USB-plug(s) and its hold-part and hold-part end's wire. The wire come out from USB male plug tail is the most weakness parts because it is joint place to hard conductive metal USB-port and electric wire and that end is the maximum bend point sometime is 90 degree or more than 90 degree so very harm to the electric wires. The current invention protect the USB male plug's hold-part and its output area wire by the surrounding walls for recess design is the first one design such recess USB receiving-ports.

From FIG. 14 is new tooled USB Charger unit has (1) USB Charger (2) Most light weight power bank has only 2 (AAA) or 2 (AA) batteries with voltage booster circuit or IC or electric-parts & accessories to supply power to all other electric device or USB Charger's other functions while USB Charger been disconnected with AC power source (3) Add LED flashlight function. So this become 3 function or Multiple functions LED device.

From FIG. 14 also has built-in add function beside the less DC voltage rechargeable batteries than the LED light source trigger voltage, so has the DC voltage booster circuit, IC, related parts & accessories to get higher DC voltage to operate the LED light which act as flashlight for lady's purse interior lighting or moving flashing light . . . etc.

From the FIG. 14A are the existing market available USB Charger and no need to redo all UL testament as current invention just move out the front USB-port(s) cover (FIG. 14B)and design a new cover with battery compartment to fit into existing USB Charger so can instant and easily to make upgrade 1 function USB Charger to become (FIG. 14C) has Portable Prong can foldable travel USB Charger+DC power Bank. This become the most light weight Power Bank with travel USB Charger.

From the FIG. 14C which main products is USB Charger similar with FIG. 14 but which is the existing model from market place so it can simple to make upgrade by move out the original cover and just make a new cover which has the USB-ports opening on bottom of the upgrade cover which has wall surrounding and wall height min. 15 mm to max 30 mm to allow all kind of USB male plug hold-parts and hold-part's end wire can be lower than the surrounding wall height so can protect the USB male plug and hold-end's wire do not damage as current market all Plug-in AC outlet USB Charger. This is great improvement for the all Plug-in AC outlet USB Charger. It is appreciated that all kind of alternative, improvement, replacement, equal function, same features with the current invention still fall within the current invention claims scope.

From the FIG. 14C further has the other wire arrangement which has the Wall opening to allow the USB male plug's wire can go though and install or fit within the gaps between the Charging circuit and the batteries it preferred called V-shape groove, gap, ditch, or space it is not limited for the groove, ditch it also can has hook, pole, catcher, extension plastic holder to install the USB male plug's wire length so the current invention also offer the wire arrangement to make the USB Charger and USB-male plugs wire including plug hold-parts and hold-part's end wire well protected. So this is other big improvement and features of the current invention. It is appreciated that all kind of alternative, improvement, replacement, equal function, same features with the current invention still fall within the current invention claims scope.

From FIG. 15 show the 4^{th} embodiment which has same as FIG. 14 concept. But has more functions can be select but not limited for listed functions as above listed and discussed features, functions. The main product for the FIG. 15 is a multiple functions Plug-into AC outlet LED light which has all same components but has more functions including (a) Night light has photos sensor or-and motion sensor (b) USB Charger with USB-ports (c) Power fail LED light same or not-same with Night light LEDs (d) Flashlight with same or not same as night light or-and power fail light LEDs (e) Most light weight Power bank with as less as possible replaceable rechargeable (AAA) (AA) (Sub C)(C) (D)(F) or available rechargeable battery can purchased at majority of Chain stores with voltage booster circuit, IC, related parts & accessories to supply higher voltage current to meet other device, functions, circuit trigger or operation or working voltage.

So the FIG. 15 show at least 5 major functions but more including the above listed and discussed including but not limited as below;
(aa) motion sensor,
(bb) remote controller,
(cc) bluetooth connection,
(dd)wireless controller,
(ee) wireless communication,
(ff) camera,
(gg) recording,
(hh) microphone,

Those functions and parts arrangement also show on the said FIG. 15 for all above listed (aa) to (hh) but the current invention is not limited for these listed built-in functions.

From FIG. 15A, FIG. 15B, FIG. 15C, FIG. 15D show the replaceable and can be rechargeable batteries or battery-assembly install on the main product's battery compartment and the main products is a LED Night light has built-in Flashing, USB Charger, power bank, power failure light and can has more built-in function as above listed (aa) to (hh) but not limited for these. It is appreciated that all market available function or effects or performance for people eyes, ears, nose, mouth, skin can sense should still fall within the said current invention's claims scope as long as has the main products has (1) Compartment for replaceable & rechargeable battery or batteries (2). Compartment batteries total DC voltage is less than required functions' Voltage (3) Compartment batteries total DC export voltage go through booster circuit to raised DC voltage to trigger or operate the desired functions. (4) The main product is Plug-into AC outlet electric device (5) The main products has more than one electric functions, effects, performance.

In the above-described embodiments, preferred images are created when the light device is activated by a switch, sensor, control means, power source, and circuit means. The light device can have any kind of design, shape, and display. The geometric shape of the substrate and spin means that incorporate the LED(s) or LED array may also be varied to provide a desired display of time, messages, words, colors, or patterns.

Although preferred embodiments of the current invention have been described above, it will be appreciated that all alternative or equivalent devices, functions, skills, arrangements, and constructions may still fall within the current scope of the current invention.

The invention claimed is:

1. An plug-into AC outlet LED Night light has replaceable rechargeable battery or batteries assembly consist of;
At least one compartment is part of the said LED night light which fit or install the said replaceable rechargeable batteries.
At least one of charging circuit to charge the said replace rechargeable battery or battery-assembly while the light plug-into AC outlet.
At least one of the said Plug-In AC outlet LED night light has AC-to-DC circuit to get Direct current to supply Direct current to LED or LEDs or-and replaceable rechargeable battery-assembly or-and other LED night light built-in functions.

2. An plug-into AC outlet LED Night light has replaceable rechargeable battery or batteries assembly as claim 1,
The said light or battery-assembly connect with Direct current voltage booster circuit which is a cost saving feature and can raise the battery or battery-assembly DC voltage while the compartment only has the less number of battery or battery-assembly, wherein the total battery or battery-assembly DC voltage is less than the desire function's required trigger or operation voltage.

3. An plug-into AC outlet LED Night light has replaceable rechargeable battery or batteries assembly as claim 1,
The said total voltage of replaceable rechargeable battery-assembly is less than the LED(s), light source or other functions built-in the said light or other product's trigger or operation voltage, so incorporate with the DC current booster circuit, IC, related parts & accessories to get higher DC voltage to get desired functions.

4. An plug-into AC outlet LED Night light has replaceable & rechargeable battery or batteries assembly as claim 1,
The said battery-assembly or light including at least one of voltage boosting IC or components and related parts and accessories to increase the lower battery-assembly's voltage to over or higher than the LED or other electric functions built-in the light or other product's trigger or operation voltage.

5. An plug-into AC outlet LED Night light has replaceable & rechargeable battery or batteries assembly as claim 1,
The said battery-assembly has compartment to install No. 1 to N (Any number) of rechargeable batteries act as power bank to supply power to other electric device or light source, sensor, wireless assembly, motion sensor, power fail light, flashlight, communication device, iphone, ipad, camera, photo device, consumer electric device while the LED light is not plug-in the said AC outlet

6. A replaceable rechargeable battery assembly has booster voltage circuit to supply DC power to the other electric device consist;
At least one of AC powered plug-in outlet electric main product has compartment(s) to install at least one of replaceable rechargeable battery assembly which can easily install, replace, assembly, dis-assembly from the compartment which has easily open, close of the battery cover, hinge, door.
The said Main product has charge circuit to charge the said battery or battery-assembly
While the main products plug-into the AC outlet with or without controller.
At least one of booster voltage circuit has related electric parts & accessories or IC to raise the less or lower the said total battery or battery-assembly's DC voltage to higher DC voltage which has enough of higher DC voltage to charge or supply DC power to other electric device(s) or main product's built-in other functions while main product not plug-into the AC outlet

7. A replaceable rechargeable battery assembly has booster voltage circuit to supply DC power to the other electric device consist as claim 6,
The said main electric device (s) also can install the available everywhere of the non-rechargeable desired size battery or battery-assembly to power other DC electric device while not plug-into the AC outlet for emergency use to power the other device or the other function built-into the said main products.

8. A replaceable rechargeable battery assembly has booster voltage circuit to supply DC power to the other electric device consist as claim 6,
The said main electric products built-in other functions or effects including but not limited of at least one or any combination from;
(1) AC plug-in outlet multiple functions LED night light,
(2) power fail light,
(3) LED light,
(4) flashlight,
(5) AC outlet Plug-in USB Charger products,
(6) Power bank
(7) Motion sensor light
(8) Camping light
(9) Motor device
(10) Camera
(11) Memory card,
(12) Wireless transmitter or receiver
(13) Portable DC Power bank can charge other USB-device by USB wires has 2 USB-plug for electric delivery.

9. A replaceable rechargeable battery assembly has booster voltage circuit to supply DC power to the other electric device consist as claim 6,
The said AC outlet plug-in electric main product has at least one of built-in functions or features with select control-kits but not limit any combination from
(a) motion sensor,
(b) remote controller,
(c) bluetooth connection,
(d) wireless controller,
(e) wireless communication,
(f) camera,
(g) recording,
(h) microphone,

10. A replaceable rechargeable battery or battery-assembly for Plug-into AC Outlet USB Charger consist of;
At least one of replaceable battery or battery-assembly has total DC voltage is lower than be charged or be powered products, functions, circuit, IC's working or operation required DC voltage.
At least one of DC voltage booster circuit, IC, related parts & accessories to raise the said lower total battery or battery-assembly's DC voltage to higher DC voltage which is higher and enough than the working or operation required DC voltage to charge or supply the said be charged or be powered products, desired functions, preferred circuit, preferred IC whenever the USB Charger disconnect the AC power source including but not limited when the power failure or USB charger carry by people while traveling.

11. A replaceable rechargeable battery or battery-assembly for Plug-Into AC Outlet More than one functions LED light consist of;
At least one of replaceable battery or battery-assembly has total DC voltage is lower than be charged or be powered products, functions, circuit, IC's working or operation required DC voltage.
At least one of DC voltage booster circuit, IC, related parts & accessories to raise the said lower total battery or battery-assembly's DC voltage to higher DC voltage which is higher and enough than the working or operation required DC voltage to charge or supply the said be charged or be powered products, desired functions, preferred circuit, preferred IC whenever the more than one function LED light disconnect the AC power source.

12. A Plug-Into AC Outlet More than one functions electric device consist of;
At least one of replaceable battery or battery-assembly inside compartment of said main product has batteries total DC voltage is lower than trigger or working or operation required DC voltage of the be charged or be powered products
At least one of DC voltage booster circuit, IC, related parts & accessories to raise the said lower DC voltage to higher voltage which is higher and enough to charge or supply the DC power to the said be charged or be powered products, functions, circuit, IC's to the required working or operation DC voltage whenever the electric device disconnect the AC power source.

13. A Plug-Into AC Outlet More than one functions USB Charger as claim 12, the said;
The said main product is a USB charger has receiving USB-ports install on recess or in-depth or lower position than the surrounding walls so can let USB male plug(s) hand hold-parts and hold-part's end wire to be protected from outside impact force apply to the said USB charger.

14. A Plug-Into AC Outlet More than one functions USB Charger as claim 12, the said;
USB charger has work with USB male plugs wires which pass though the said wall's opening, cutout, hole and fit or install on the groove, ditch, gaps or has the retractable bar, holder, hook, holder, plastic lips to hold to make wire arrangement so can protect the USB male plug wire sets from break inner conductive wires or damage wire.

15. A Plug-Into AC Outlet More than one functions USB Charger as claim 12, the said;
The said main products has total batteries DC voltage is lower than the said other products which including but not limited is an USB charger has other functions, the circuit inside the main products, other products, or IC inside main products, USB Charger, Flashlight, Night light, power fail light, wireless controller electric device, camera device or any main products has other function(s) those all need more higher DC voltage for working or operation desired functions or effects.
